(19) United States
(12) Patent Application Publication
(10) Pub. No.: US 2026/0270280 A1
(43) Pub. Date: Sep. 10, 2026

(54) GENERATIVE ARTIFICIAL INTELLIGENCE-BASED SYSTEMS AND METHODS FOR IDENTIFYING ANOMALOUS DATA

(71) Applicant: State Farm Mutual Automobile Insurance Company, Bloomington, IL (US)

(72) Inventors: Ross Wheeler, Scottsdale, AZ (US); Lauren Mitchell, Phoenix, AZ (US); Jose I. Gutierrez, Laveen, AZ (US); Anthony Welcome, Mesa, AZ (US); Steve Amancha, Tempee, AZ (US); Tishauna Wilson, Tampa, FL (US); Creighton Green, Gilbert, AZ (US)

(21) Appl. No.: 19/282,182

(22) Filed: Jul. 28, 2025

Related U.S. Application Data
(60) Provisional application No. 63/767,394, filed on Mar. 5, 2025.

(51) Int. Cl. H04L 9/40

(52) U.S. Cl. CPC H04L 63/1425; H04L 63/1416

(57) ABSTRACT

A computer system is provided that detects anomalies, and is programmed to (i) access one or more artificial intelligence (AI) models trained to analyze data and identify data anomalies associated with the data, (ii) receive a plurality of initial user data, (iii) receive at least one new user data, (iv) input the at least one new user data into one or more AI models to detect one or more anomalies within the received new user data by comparison to the plurality of initial user data, and (v) in response to the one or more AI models detecting one or more data anomalies within the at least one new user data, transmit one or more notifications to a user computing device including a message identifying the detected data anomaly.

### CROSS-REFERENCE TO RELATED APPLICATIONS

The current patent application claims the benefit of U.S. Provisional Application Serial No. 63/767394, filed Mar. 5, 2025, and entitled “GENERATIVE ARTIFICIAL INTELLIGENCE-BASED SYSTEMS AND METHODS FOR IDENTIFYING ANOMALOUS DATA,” the disclosure of which is hereby incorporated herein by reference in its entirety.

### FIELD OF THE DISCLOSURE

The present disclosure relates to a data analysis using generative AI (GenAI) tools and techniques, and more particularly, to GenAI-based systems and methods for analyzing images and text to detect anomalous data, and output remedial actions based upon the detected anomalies.

### BACKGROUND

Images, text, appraisals, and other data associated with objects and events may often be stored and received in large numbers for the purpose of documenting events including, in some cases, for documenting them for insurance purposes. In some cases, data may be evaluated so that information included in the data may be better understood and/or labeled so that further processing may occur. Evaluation of such data may be a labor-intensive process and may be dependent upon subject matter expertise.

In the context of evaluating images, using known systems for evaluating a particular image, it may be that the more complicated the image, the greater the likelihood that the image may be mis-labeled or mis-identified. Also, using known image analysis systems, the more complicated the image, the more computational resources may be needed to evaluate the image. In many cases, the images provided may contradict some other information provided through another means, or may contain anomalies related to one or more pieces of associated or known information. Furthermore, differences in angle, lighting, resolution, coloration, and/or other differences may greatly increase the processing cost of the image analysis systems. Likewise, many of the same problems may exist for analysis of complex and/or domain-specific text, appraisals, and other documents.

In some cases, images that get submitted for review may be duplicates of other previously submitted images, or may be manipulated in some way. It may be necessary to determine which images are duplicates of other images, and which images have been altered or changed in some way.

Insurers receive immense volumes of complex data related to insurance events every day including image data. Accordingly, it may be desirable to have a computer system to improve analysis of received data to identify anomalous data, while reducing labor and computational expenses associated therewith. Conventional techniques may have additional ineffectiveness, inefficiencies, encumbrances, and/or other drawbacks as well.

### BRIEF SUMMARY

The present embodiments may relate to, inter alia, a data analysis tool, and more particularly, to a generative artificial intelligence (GenAI)-based system and method for analyzing data including images, notes, appraisals, valuations, and/or any other submitted information to detect, identify, and resolve issues or data anomalies that may be present. The computer systems and computer-implemented methods described herein may provide for analyzing images, notes, appraisals, valuations, and/or any other submitted information to detect and identify any issues, changes, modifications, alterations, and/or duplications associated with those images and determine actions or operations to resolve those issues. The systems and methods described herein may further include a plurality of models trained to recognize features in the images, notes, appraisals, and/or valuations (collectively referred to herein as “data files”), where the features are analyzed to identify any potential issues in the images, notes, appraisals, and/or valuations.

In one aspect, a computer system for identifying anomalous data may be provided. The computer system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another and each may operate as an input and/or output device. For instance, the computer system may include at least one processor in communication with at least one memory device. The at least one processor may be configured to: (i) access one or more artificial intelligence (AI) models trained to analyze data and identify data anomalies associated with the data, (ii) receive a plurality of initial user data, (iii) receive at least one new user data, (iv) input the at least one new user data into one or more AI models to detect one or more anomalies within the received new user data by comparison to the plurality of initial user data, and (v) in response to the one or more AI models detecting one or more data anomalies within the at least one new user data, transmit one or more notifications to a user computing device including a message identifying the detected data anomaly.

In another aspect, a computer implemented method for identifying anomalous data is provided. The method may be implemented on one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another and each may operate as an input and/or output device. For instance, the method may be implemented by at least one processor in communication with at least one memory device. The method may include (i) accessing one or more artificial intelligence (AI) models trained to analyze data and identify data anomalies associated with the data, (ii) receiving a plurality of initial user data, (iii) receiving at least one new user data, (iv) inputting the at least one new user data into one or more AI models to detect one or more anomalies within the received new user data by comparison to the plurality of initial user data, and (v) in response to the one or more AI models detecting one or more data anomalies within the at least one new user data, transmitting one or more notifications to a user computing device including a message identifying the detected data anomaly. The method may include additional, less, or alternate functionality, including that discussed elsewhere herein.

In still another aspect, a non-transitory computer readable medium having computer-executable instructions embodied thereon may be provided. When executed by at least one processor, the computer-executable instructions cause the at least one processor to: (i) access one or more artificial intelligence (AI) models trained to analyze data and identify data anomalies associated with the data, (ii) receive a plurality of initial user data, (iii) receive at least one new user data, (iv) input the at least one new user data into one or more AI models to detect one or more anomalies within the received new user data by comparison to the plurality of initial user data, and (v) in response to the one or more AI models detecting one or more data anomalies within the at least one new user data, transmit one or more notifications to a user computing device including a message identifying the detected data anomaly.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates a block diagram of an exemplary computing system for analyzing data files for data anomalies in accordance with the present disclosure.

FIG. 2 illustrates a block diagram of an exemplary computer-implemented process of identifying anomalous data within data files including images in accordance with the present disclosure.

FIG. 3 illustrates an exemplary computer-implemented process of identifying duplicate data within data files in accordance with the present disclosure.

FIG. 4 illustrates an exemplary computer-implemented process of identifying anomalous appraisal data within data files in accordance with the present disclosure.

FIG. 5 illustrates an exemplary configuration of a user computer device in accordance with one embodiment of the present disclosure.

FIG. 6 illustrates an exemplary configuration of a server computer device in accordance with one embodiment of the present disclosure.

FIG. 7 illustrates an exemplary configuration of an artificial intelligence portion of the computer system of FIG. 1.

FIG. 8 illustrates an exemplary computer-implemented process of identifying anomalous data within data files including images in accordance with the present disclosure.

FIG. 9 illustrates an exemplary computer-implemented process of identifying anomalous appraisal data within data files in accordance with the present disclosure.

FIG. 10 illustrates an exemplary computer-implemented process of identifying anomalous appraisal data within data files in accordance with the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, network-based systems and methods that uses GenAI tools to analyze data to detect, identify, and/or remediate data anomalies identified within the data files, and/or perform one or more downstream tasks based upon the analysis of the data. In one exemplary embodiment, the process may be performed by an AI analysis computer device. In the exemplary embodiment, the AI analysis computer device may be in communication with one or more user devices, one or more analysis models, and/or one or more user computer devices. As described below in further detail, the AI analysis computer system includes one or more data evaluating models that are trained to recognize different types of objects in images, key features in text or other data files, and output one or more determinations based upon analysis of the received data. Data evaluating models may include one or more AI models, including a Gen AI model. The systems and methods described herein automate data analysis to improve detection of anomalous data, reduce computational expenses, and/or reduce inconvenience.

In some embodiments, the AI analysis computer system allows an insurer to receive data relating to one or more images. Images received may be associated with a user and an event (e.g., a car accident, a leak in a home, etc.). The AI analysis computer system store one or more models for analyzing images to identify anomalies associated with the images. The AI analysis computer system stores a plurality of initial images corresponding to a plurality of historical events and users.

Upon receipt of a new image, the AI analysis computer system executes the one or more models to detect one or more anomalies associated with the new image. Detection of an anomaly might include, for example, detecting that an image has an AI watermark, detecting that an image has been modified in some way, detecting that the image has been generated by AI, and/or by detecting that the image does not pass a threshold criteria for realism. Detection of an anomaly may include comparing a feature of the new image to a similar feature of the plurality of initial images to determine if the feature of the new image is consistent with the feature found in the plurality of initial images. Comparison of features may include analyzing a saturation value, a color value, a brightness value, a texture, a context score, a color distribution, a realism score, and/or other data associated with the images.

In other embodiments, the AI analysis computer system allows an insurer to receive user data relating to one or more insurance events. The AI analysis computer system store one or more models for analyzing user data to identify anomalies associated with the user data. Insurance events might include, for example, a car accident, medical event, and/or property damage. The AI analysis computer system may store a plurality of initial user data associated with existing insurance events. User data may include text notes such as Standard, Objective, Assessment, Plan notes (SOAP notes), images, and/or other data associated with the insurance event. Upon receipt of a new user data, the AI analysis computer system executes the one or more models to detect one or more anomalies associated with the new user data. Detection of an anomaly may include comparing a similarity score of the new user data and the plurality of initial user data to determine if data has been reused with alterations, and/or detecting that portions of images or SOAP notes have been replicated or reused.

A technical effect of the systems and processes described herein may be achieved by performing at least one of the following actions or operations: a) improving efficiency of anomalous data detection by analyzing only portions of images through feature identification and extraction; b) reducing the effect of fraudulent claims and data by improving detection of anomalous data; c) improving efficiency of detection of images made using generative AI through use of generative AI to identify AI watermarks; d) improving efficiency and accuracy of anomalous data detection of images through feature identification and extraction; e) improving the detection of generative AI images through computation of a realism score based upon image features; f) decreasing the impact of fraudulent or anomalous data by automatically taking remedial action upon detection of anomalies; g) improving the detection of duplicate data using generative AI; and/or h) improving detection of fraudulent appraisals and appraisal vendors using generative AI.

### Exemplary Process for Identifying Issues

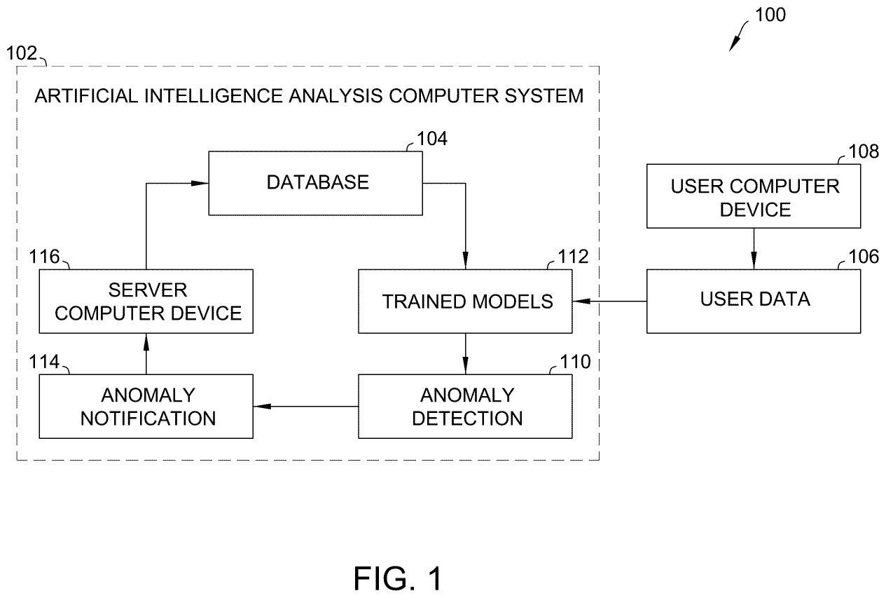

FIG. 1 illustrates a block diagram of an exemplary computing system 100 for detecting data anomalies in data files that include, for example, images, text data, data related to appraisals of items or property, SOAP notes, and/or event documentation.

In the exemplary embodiment, an artificial intelligence analysis (AIA) computing device 102 accesses a database 104 containing a plurality of existing user data. The plurality of existing user data can include images, text, events, user profiles, and/or other information relating to one or more insurance events. The AIA computer system 102 uses the database 104 to train one or more models 112 to recognize different scenarios that might indicate the presence of anomalous data. The one or more models 112 may receive training images including a plurality of historical images that are predetermined as being authentic images; and train the one or more models using training images. Authentic images may include images that have been verified to be non-AI generated or modified and/or have below a certain threshold of alterations or modifications. The plurality of historical images may include images previously received by the system and/or submitted by users.

In the exemplary embodiment, the AIA computer system 102 receives new user data 106 from user computer device 108. The new user data may include images, text, events, user profiles, and/or other information relating to one or more insurance events. For example, the new user data 106 might include an image of a car accident, an image of an item submitted with an appraisal for insurance, and/or SOAP notes related to an insurance event. In some embodiments, the AIA computer system 102 extracts one or more pieces of metadata from the images, including time and/or date. In various embodiments, the AIA computer system 102 stores user data 106 within memory that is easily retrievable and comparable for AI purposes.

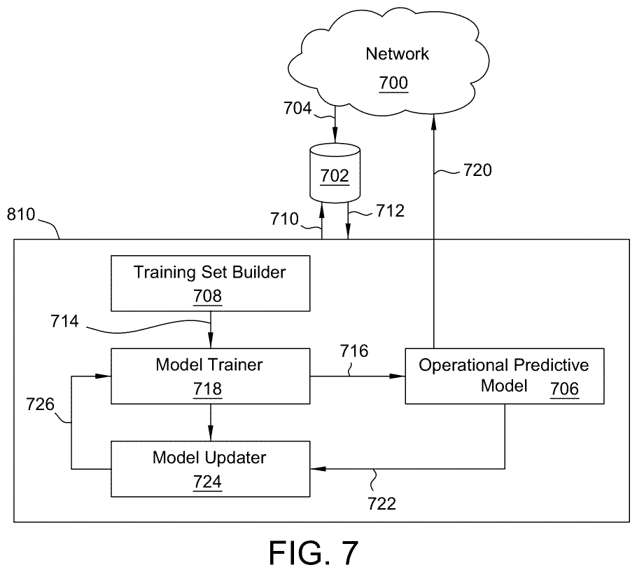

In the exemplary embodiment, the AIA computer system 102 then performs anomaly detection 110 on the received user data 106. Anomaly detection 110 may include assessing whether an image of the user data 106 is AI generated, determining whether user data is a duplicate of, or similar to, existing user data in the database 104, and/or verifying the authenticity and valuation of an appraisal. Anomaly detection may be performed by one or more trained models 112, including a generative AI (see FIG. 7).

If the AIA computer system 102 detects an anomaly, the AIA computer system 102 generates an anomaly notification 114. Anomaly notification 114 may include transmitting a notification to a device such as server computer device 116, flagging the user data 106 as anomalous, storing and sending the data to the database 104 to use in further training or building of the trained models 112, initiating a remedial measure, generating a report or valuation, and/or declining a claim associated with the user data 106.

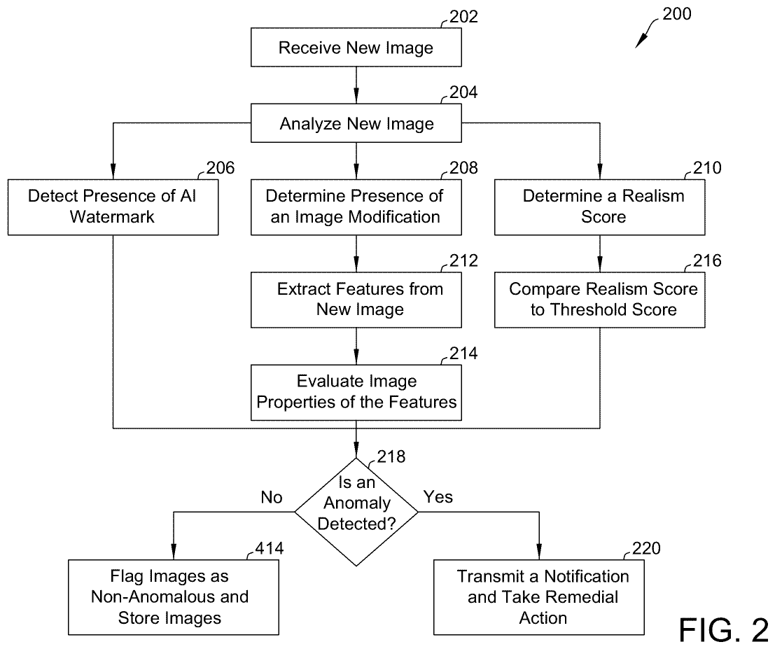

FIGS. 2, 3, and 4 demonstrate exemplary processes for detecting anomalies in user data, in accordance with embodiments of the present disclosure. In the exemplary embodiment, the functionality or operations of process 200, 300, and 400 may be performed by the AIA computer system 102 (shown in FIG. 1), in communication with one or more trained models 112 (shown in FIG. 1), one or more third party servers, and/or a prompt engineering system.

### Exemplary Process For Detecting Image Anomalies

FIG. 2 is a flowchart showing an exemplary process 200 for detecting one or more anomalies related to images in user data. The AIA computer system 102 receives 202 a new image from newly received data from a user. The new image may be associated with a user and an event.

In the exemplary embodiment, the AIA computer system 102 analyzes 204 the new image to detect an anomaly associated with the image. Analyzing 204 the new image may include detecting 206 the presence of an AI watermark, determining 208 the presence of an image modification, and/or determining 210 a realism score associated with the image.

In the exemplary embodiment, detecting 206 the presence of an AI watermark may include analyzing the image for one or more known or suspected watermark patterns. For example, detecting 206 may include analyzing the image to determine the presence of an AI watermark, such as by extracting and analyzing features associated with the image, assessing the image for one or more regions having different color properties (e.g., brightness, color distribution, etc.), searching the image for visible or hidden text, analyzing the metadata of the image, comparing the image to other images containing known AI watermarks, and/or performing one or more cryptographic functions to determine the presence of a watermark.

In the exemplary embodiment, determining 208 the presence of an image modification may include detecting an image modification based upon at least one image property, including: a saturation value, a color value, a brightness value, a texture, a context score, and/or a color distribution. Trained models 112 may extract 212 and identify one or more features or objects in the image, such as cars, trees, walls, etc. Feature extraction may be guided by metadata or other user data associated with the image-for example, in an image associated with a car crash, features extraction might ignore some background objects in favor of extracting features associated with crash data, including cars, tire marks, damaged areas on a vehicle, and guard rails. The image as a whole may be analyzed for modifications, or only those extracted features may be analyzed to save computational expenses and improve speed of analysis.

In the exemplary embodiment, AIA computer system 102 may evaluate 214 image properties of the image as a whole, or may evaluate 214 image properties associated with the identified features. The presence of regions in the image with unnatural image property values such as color, saturation, brightness, and/or overall color distribution values may indicate the presence of a modification. For example, trained models 112 may identify areas of an image having unnaturally even or otherwise anomalous color, saturation, color distributions, and/or brightness values as evidence that the pixels have been replaced or modified. AIA computer system 102 may generate an image property discrepancy score based upon the analysis of the color, saturation, and/or brightness. If the image property discrepancy score exceeds a threshold value, an anomaly is detected.

In the exemplary embodiment, AIA computer system 102 may identify discrepancies in texture which indicate the presence of an image modification. Trained models 112 may be trained to recognize textures associated with extracted features. For example, brick walls have a certain texture pattern associated with the surface of the bricks and the mortar. AIA computer system 102 may compare the texture of the new image to the textures known by trained models 112 or known non-anomalous textures stored in database 104 to generate a texture discrepancy score. If the texture discrepancy score exceeds a threshold value, an anomaly is detected.

In the exemplary embodiment, AIA computer system may generate a context score associated with the image. A context discrepancy score includes information associated with the context surrounding an event in the image. For example, in an image of a car crash involving braking, it might be expected that tire marks are present in the image. Trained models 112 identify context based upon training from existing data and generate a context score for the image based upon expected context. Expected context may be derived from identified features or metadata associated with the image (e.g., the image is marked as “car crash”). If the context discrepancy score exceeds a threshold value, an anomaly is detected.

In the exemplary embodiment, AIA computer system may determine 210 a realism score associated with an image. AI generated images often have a “cartoony” look and may have unnatural colors, textures, combinations of features, and/or may include discrepancies in other image properties. The trained models 112 of the AIA computer system 102 may be trained on both real and AI-generated images to identify image properties associated with AI images. AIA computer system 102 may generate a realism score that represents the similarity of the image features to that of an AI generated or AI modified image. The realism score may be compared 216 to a threshold value, and if the realism score exceeds the threshold value, an anomaly is detected.

In some embodiments, the realism score, texture discrepancy score, context score, and/or image property discrepancy score may be combined or averaged and compared to an overall threshold value to determine the presence of an anomaly. If the combination of scores exceeds the overall threshold value, an anomaly is detected 218.

In the exemplary embodiment, if an anomaly is detected, AIA computer system 102 transmits 220 a notification to indicate that the received new image is anomalous. The notification may be transmitted to at least one of the server computer device 116 and/or the user computer device 108. Additionally, AIA computer system 102 may take one or more remedial measures. For example, AIA computer system 102 may rectify a detected image modification, implement one or more security measures, deploy one or more additional anomaly detection processes, flag the image as anomalous, and/or decline a claim associated with the image based upon the detection of the anomaly.

In the exemplary embodiment, if an anomaly is not detected in a received image, AIA computer system 102 transmits 220 a notification to indicate that the received new image is not anomalous. AIA computer system 102 may flag the image as “not anomalous” 414 and store the image in database 104. Non-anomalous images may be added to the training set and used to build or train the trained models 112.

### Exemplary Process for Detecting Duplicate Data

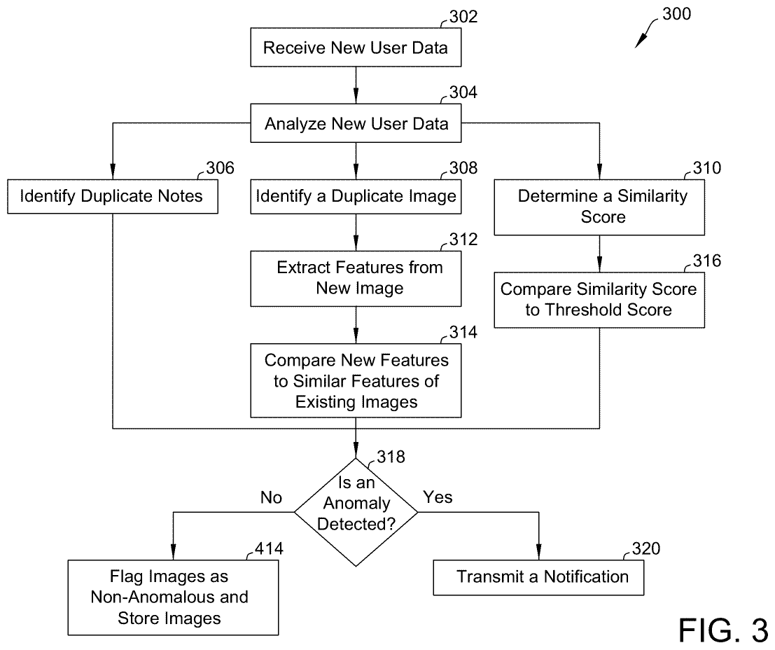

FIG. 3 is a flowchart showing an exemplary process 300 for detecting one or more anomalies related to user data. The AIA computer system 102 receives 302 new user data from a user. The new user data may be associated with a user and an event, and may include, for example, images, text data, data related to appraisals of items or property, SOAP notes, and/or event documentation.

In the exemplary embodiment, AIA computer system 102 analyzes 304 new user data to detect one or more anomalies. Analysis of the new user data may include identifying 306 duplicate notes, identifying 308 a duplicate image, and/or determining 310 a similarity score between the new user data and existing user data.

In the exemplary embodiment, identifying 306 duplicate notes may include comparing notes of the new user data to notes from existing user data in the database 104. AIA computer system 102 may execute the trained models 112 to identify duplicate notes or duplicate portions of the notes. Identification of duplicate notes may include identifying duplicate portions of text, images, key phrases, and/or other content associated with the notes.

In the exemplary embodiment, identifying 308 duplicate images may include identifying and extracting 312 one or more features from an image of the new user data. Trained models 112 may extract one or more features in the image, such as objects or people. The extracted features of the new user data may be compared 314 against similar features in existing user data. For example, if an extracted feature is a “red sedan,” AIA computer system 102 compares the red sedan in the new image against some or all red sedans in existing user data store in the database 104. If the feature is the same as an existing feature, the feature may be labeled a duplicate feature and an anomaly is detected. In some embodiments, the entire image is compared against existing images in the database 104 to determine if the image is a duplicate.

In the exemplary embodiment, AIA computer system 102 determines 310 a similarity score based upon a comparison between new user data and existing user data. For example, if portions of an image are similar, or if certain phrases or sections of text in notes of the new user data appear in existing user data, then an anomaly may be present in the data. The similarity score may be calculated as an output of the execution of trained models 112. The similarity score may be compared 316 to a threshold score. If the similarity score exceeds the threshold score, an anomaly is detected.

In some embodiments, exceptions may be made to the anomaly detection based upon duplication or similarity. For example, if a user submits a duplicate image of their own vehicle on two separate occasions, the AIA computer system may identify that the reason for duplication of the feature is due to common ownership of the vehicle, or that the duplicate image is being resubmitted to show the past condition of the vehicle.

In the exemplary embodiment, AIA computer system 102 may generate a reliability score for the new user data based upon a user history. For example, if the new user data includes SOAP notes, AIA computer system may analyze the user history associated with the provider or author of the SOAP notes to determine if there are prior instances of submitted anomalous data. A high reliability score may indicate that the provider has not submitted duplicate data in the past, while a low reliability score may indicate one or more instances of duplicated data submitted in the past. AIA computer system 102 may compare the reliability score to a threshold value, and an anomaly may be detected if the reliability score is beneath the threshold value.

In the exemplary embodiment, if an anomaly is detected 318, AIA computer system 102 transmits 320 a notification to indicate that the received new data is anomalous. The notification may be transmitted to at least one of the server computer device 116 and/or the user computer device 108. Additionally, AIA computer system 102 may take one or more remedial measures. For example, AIA computer system 102 may remove duplicated data from the new user data or a copy of the new user data, implement one or more security measures, deploy one or more additional anomaly detection processes, flag the data as anomalous, and/or decline a claim associated with the data based upon the detection of the anomaly.

In the exemplary embodiment, if an anomaly is not detected in a received image, AIA computer system 102 transmits 320 a notification to indicate that the received new image is not anomalous. AIA computer system 102 may flag the image as non-anomalous 414 and store the image in database 104. Non-anomalous images may be added to the training set and used to build or train the trained models 112. In some embodiments, anomalous images may also be stored in the database 104 and used to build or train the trained models 112.

### Exemplary Process for Detecting Validating Appraisals

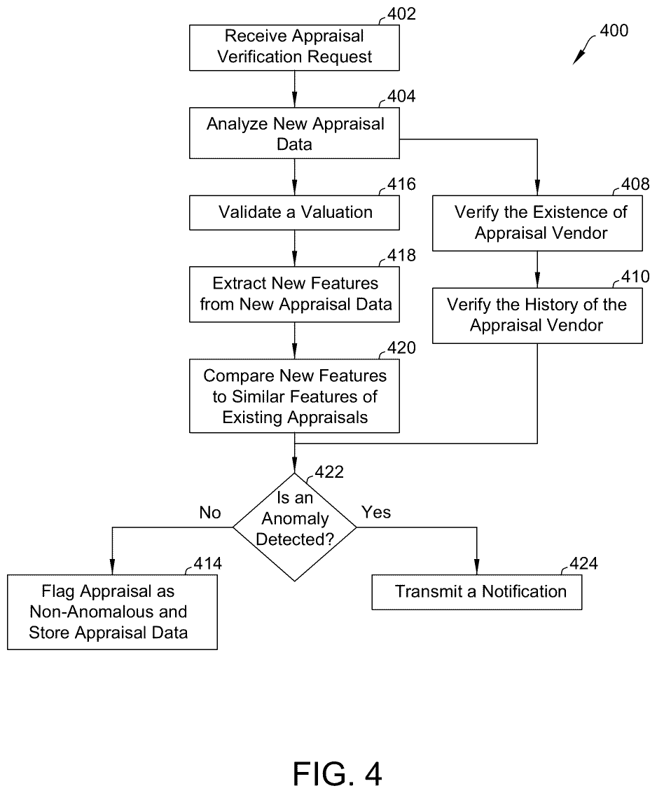

FIG. 4 is a flowchart showing an exemplary process 400 for detecting one or more anomalies related to appraisals. The AIA computer system 102 receives 402 new appraisal data from a user, in the form of an appraisal verification request. The appraisal verification request may be associated with a user, one or more items, a valuation, and/or an event.

The AIA computer system 102 analyzes 404 new appraisal data. Analysis of new appraisal data may include validating 406 a valuation, verifying 408 the existence of an appraisal vendor, and/or verifying 410 the history of an appraisal vendor.

Validating 416 a valuation may include comparing the valuation of an item associated with the appraisal verification request to one or more known valuations of similar items in the database 104. Validating 416 the valuation may include extracting 418 new features from the new appraisal data, such as the type of the item, the condition of the item, the age of the item, the time the appraisal was performed, and/or one or more other values associated with the appraisal. Extraction 418 of features may be performed by trained models 112.

AIA computer system 102 may compare 420 the extracted features of the new appraisal data to existing features from existing appraisals in the database. AIA computer system 102 may generate an appraisal accuracy score based upon the comparing 420, and compare the appraisal accuracy score to a threshold score. If the appraisal accuracy score is below the threshold score, an anomaly is detected 422.

In the exemplary embodiments, the AIA computer system 102 verifies 408 the existence of the appraisal vendor associated with the new appraisal data. Verification 408 of the existence of the appraisal vendor may include check against known vendors of prior appraisals in the database 104, and/or checking against a list of known or certified vendors located outside the database 104. Verification 408 may include comparing one or more known pieces of information, such as a certification, tax identification number, business entity name, business entity information, and/or other identifying information. If the verification 408 reveals that no known vendor matches the information of the vendor associated with the new appraisal data, an anomaly is detected 422.

In the exemplary embodiments, AIA computer system 102 verifies the history of the appraisal vendor. Verification of the history of the appraisal vendor may include checking for one or more known anomalies associated with the vendor's prior appraisals. For example, if the appraisal vendor has a history of fraud, a history of inaccurate valuations, and/or another anomalous behavior, an anomaly may be detected 422.

In the exemplary embodiment, if an anomaly is detected, AIA computer system 102 transmits 424 a notification to indicate that the received new appraisal data is anomalous. The notification may be transmitted to at least one of the server computer device 116 and/or the user computer device 108. Additionally, AIA computer system 102 may take one or more remedial measures. For example, AIA computer system 102 may flag, generate, and/or modify a vendor profile associated with the vendor of the new appraisal data, generate a predicted or revised valuation, implement one or more security measures, deploy one or more additional anomaly detection processes, flag the new appraisal data as anomalous, and/or decline a claim associated with the data based upon the detection of the anomaly.

In the exemplary embodiment, if an anomaly is not detected in a received image, AIA computer system 102 transmits 424 a notification to indicate that the received new image is not anomalous. AIA computer system 102 may flag the image as non-anomalous 414 and store the image in database 104. Non-anomalous images may be added to the training set and used to build or train the trained models 112. In some embodiments, anomalous images may also be stored in the database 104 and used to build or train the trained models 112.

### Exemplary Client Device

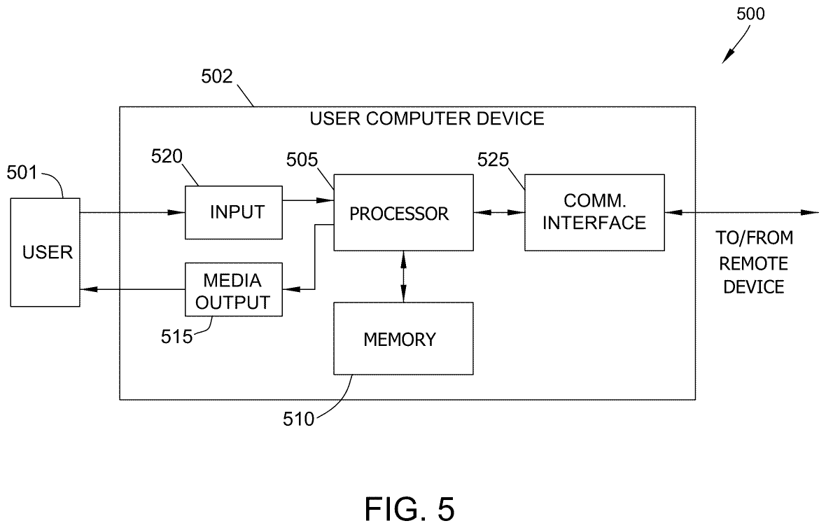

FIG. 5 depicts an exemplary configuration 500 of user computer device 502, in accordance with one embodiment of the present disclosure. In the exemplary embodiment, user computer device 502 may be similar to, and/or the same as, user computer device 108 (shown in FIG. 1). User computer device 502 may be operated by a user 501.

User computer device 502 may include a processor 505 for executing instructions. In some embodiments, executable instructions may be stored in a memory area 510. Processor 505 may include one or more processing units (e.g., in a multi-core configuration). Memory area 510 may be any device allowing information such as executable instructions and/or transaction data to be stored and retrieved. Memory area 810 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively couplable to an output device such as a display device (e.g., a cathode ray tube (CRT), liquid crystal display (LCD), light emitting diode (LED) display, and/or “electronic ink” display) or an audio output device (e.g., a speaker or headphones).

In some embodiments, media output component 515 may be configured to present a graphical user interface (e.g., a web browser and/or a client application) to user 801. A graphical user interface may include, for example, an interface for viewing items of information provided by the AIA computer system 100 (shown in FIG. 1). In some embodiments, user computer device 502 may include an input device 520 for receiving input from user 501. User 501 may use input device 520 to, without limitation, provide information either through speech or typing.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as AIA computer system 100. Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from AIA computer system 100. A client application may allow user 501 to interact with, for example, AIA computer system 100. For example, instructions may be stored by a cloud service, and the output of the execution of the instructions sent to the media output component 515.

### Exemplary Server Device

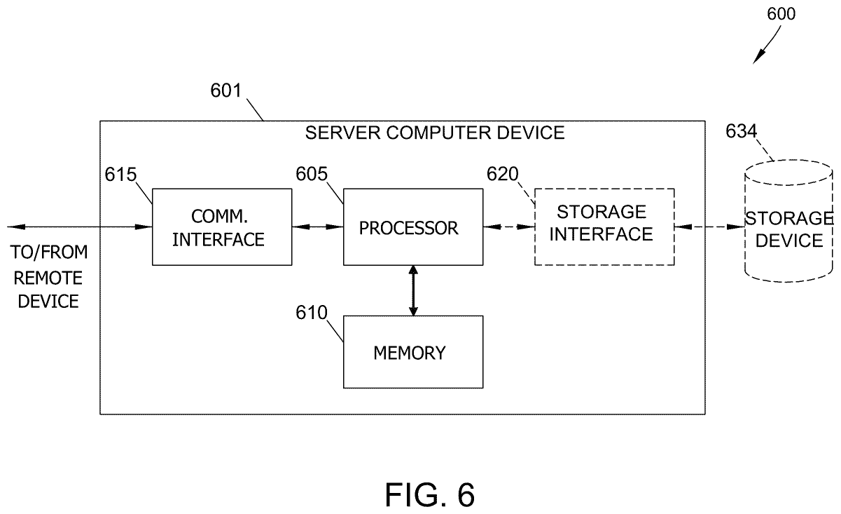

FIG. 6 depicts an exemplary configuration 600 of a server computer device 601, in accordance with one embodiment of the present disclosure. In the exemplary embodiment, server computer device 601 may be similar to, or the same as, server computer device 116 (shown in FIG. 1), and database 104. Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, AIA computing system 100, and user computer devices 502 (shown in FIG. 5) (for example, using wireless communication or data transmission over one or more radio links or digital communication channels). For example, communication interface 615 may audio input from user computer devices 502 via the Internet.

Processor 605 may also be operatively coupled to a storage device 634. Storage device 634 may be any computer-operated hardware suitable for storing and/or retrieving data, such as, but not limited to, data associated with one or more models. In some embodiments, storage device 634 may be integrated in server computer device 601. For example, server computer device 601 may include one or more hard disk drives as storage device 634.

In other embodiments, storage device 634 may be external to server computer device 601 and may be accessed by a plurality of server computer devices 601. For example, storage device 634 may include a storage area network (SAN), a network attached storage (NAS) system, and/or multiple storage units such as hard disks and/or solid-state disks in a redundant array of inexpensive disks (RAID) configuration.

In some embodiments, processor 605 may be operatively coupled to storage device 634 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instruction such as illustrated in FIGS. 2-4.

### Exemplary Computer System

FIG. 7 is a schematic diagram of a portion of exemplary Artificial Intelligence Analysis (AIA) computer device 102 (shown in FIG. 1). AIA computer device may communicate with other components of system 100, such as third-party servers, client computer devices 502 (shown in FIG. 5), user computer device 108, server computer and/or server computer devices 601.

AIA computer device 100 may include and/or be in communication with a database 702 that stores data 704, such as database 104 (shown in FIG. 1), stored records generated by AIA computer device 100, and/or any other relevant data s described herein. Data 704 received from network 700 may be stored in database 702. AIA computer device 102 may configured to use data 704 to generate an operational AI module 706 analyzes images, detecting image anomalies, parsing appraisal verification requests, and the like.

In exemplary embodiments, AIA computer device 102 may include a training set builder module 708 configured to submit one or more queries 710 to database 702 to retrieve subsets 712 of data 704, and to use those subsets 712 to build training data sets 714 for generating AI module 706. For example, query 710 may be configured to retrieve certain fields from data 704 for a specific feature, a specific category, and/or any other division of factors desired by the user.

In various embodiments, training set builder module 708 may be configured to derive training data sets 714 from retrieved subsets 712. Each training data set 714 corresponds to a historical data 704 (“historical” in this context means completed in the past, as opposed to completed in real-time with respect to the time of retrieval). Each training data set 714 may include “model input” data fields along with at least one “result” data field representing a historical outcome associated with the model input. The model input data fields represent factors that may be expected to, or unexpectedly be found during model training to, have some correlation.

In exemplary embodiments, the model input data fields in training data sets 714 may be generated from data fields in subset 712 corresponding to historical data 704. In other words, a trained machine learning model 716 produced by a model trainer module 718 for use by AI module (also known as Operational Predictive Model) 706 is trained to make predictions based upon input values that can be generated from the data fields in data 704. Values in the model input data fields may include values copied directly from values in a corresponding data field in the retrieved subset 712, and/or values generated by modifying, combining, and/or otherwise operating upon values in one or more data fields in the retrieved subset 712. The use of such data fields as model input data fields facilitates the machine learning model in weighing these factors directly.

After training set builder module 708 generates training data sets 714, training set builder module 708 passes the training data sets 714 to model trainer module 718. In certain embodiments, model trainer module 718 may be configured to apply the model input data fields of each training data set 714 as inputs to one or more machine learning models. Each of the one or more machine learning models may be programmed to produce, for each training data set 714, at least one output intended to correspond to, or “predict,” a value of the at least one result data field of the training data set 714. “Machine learning” refers broadly to various algorithms that may be used to train the model to identify and recognize patterns in existing data in order to facilitate making predictions for subsequent new input data.

Model trainer module 718 may be configured to compare, for each training data set 714, the at least one output of the model to the at least one result data field of the training data set 714, and apply a machine learning algorithm to adjust parameters of the model in order to reduce the difference or “error” between the at least one output and the corresponding at least one result data field. In this way, model trainer module 718 trains the machine learning model to accurately predict the value of the at least one result data field.

In other words, model trainer module 718 cycles the one or more machine learning models through the training data sets 714, causing adjustments in the model parameters, until the error between the at least one output and the at least one result data field falls below a suitable threshold, and then uploads at least one trained machine learning model 716 to AI module 706 for application to data analysis 720. In exemplary embodiments, model trainer module 718 may be configured to simultaneously train multiple candidate machine learning models and to select the best performing candidate for each result data field, as measured by the “error” between the at least one output and the corresponding result data field, to upload to operational predictive model module 706.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer module 718 cycles through the training data sets 714, model trainer module 718 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 718 may provide an advantage by automatically discovering and properly weighting complex, second-or third-order, and/or otherwise nonlinear interconnections between the model input data fields and the at least one output. Absent the machine learning model, such connections are unexpected and/or undiscoverable by human analysts.

The AIA computer device 102 of the present disclosure may be configured to operate on input data related to pricing models, image features, and complete images, including to receive, review, and respond to inquiries and submissions from a user device 108. In one exemplary embodiment, AIA computer device 102 executes the AI module 702 programmed to learn, without limitation, the veracity of data based upon varying events and details, relevant data sources for evidence, the queries used to prompt a user to provide relevant information, features of claims or evidence related to potential fraud, and the like.

To facilitate this learning, AIA computer device 102 may include one or more databases 702 at which the data, including data as well as responses, evidence, outcomes, etc., is stored. This data becomes one or more input training sets used by the training set builder 708. Model outputs can be formatted for presentation or review as visual representations of recommendations, as text-based or natural language recommendations, and the like. In exemplary embodiments, AI module 706 may compare feedback, and may route a comparison result 722 generated by comparing data analysis 720 to the feedback to a model updater module 724 of AIA computer device 102. Model updater module 724 is configured to derive a correction signal 726 from comparison results 722 received for one or more analyses, and to provide correction signal 726 to model trainer module 718 to enable updating or “re-training” of the at least one machine learning model to improve performance. The retrained at least one machine learning model 716 may be periodically re-uploaded to operational predictive model module 706.

### Exemplary Computer-Implemented Method for Detecting Image Anomalies

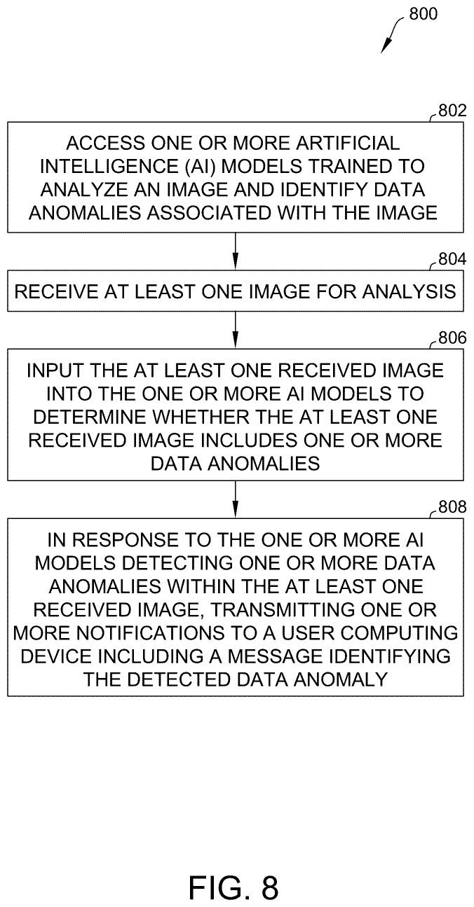

FIG. 8 illustrates a flow chart of an exemplary computer-implemented process 800 for identifying data anomalies associated with images. Process 800 may be implemented, at least in part, by a computing device/server, for example, user computing device 502 (shown in FIG. 5), server computer device 601 (shown in FIG. 6) and/or AIA computer device 102 (shown in FIG. 1).

Process 800 may include accessing 802 one or more AI models trained to analyze an image and identify data anomalies associated with the image. AI models may be trained based upon prior submitted images stored in a database, and/or may be retrained based upon newly received images.

Process 800 may include receiving 804 at least one image for analysis. Images may be received from a user computer device, server computer device, may be retrieved from a database, and/or may be received in connection with one or more other pieces of data, such as an insurance event.

Process 800 may include inputting 806 the at least one received image into the one or more AI models to determine whether the at least one received image includes one or more data anomalies. Detection of anomalies may include at least detecting one of an AI watermark, an image modification, a realism score, and/or a similarity score to known images.

Process 800 may include, in response to the one or more AI models detecting one or more data anomalies within the at least one received image, transmitting 808 one or more notifications to a user computing device including a message identifying the detected data anomaly. Transmission of notifications may include at least one of may include at least one of rectifying a detected image modification, implementing one or more security measures, deploying one or more additional anomaly detection processes, flagging the image as anomalous, and/or declining a claim associated with the image based upon the detection of the anomaly.

### Exemplary Computer-Implemented Method for Detecting Duplication Anomalies

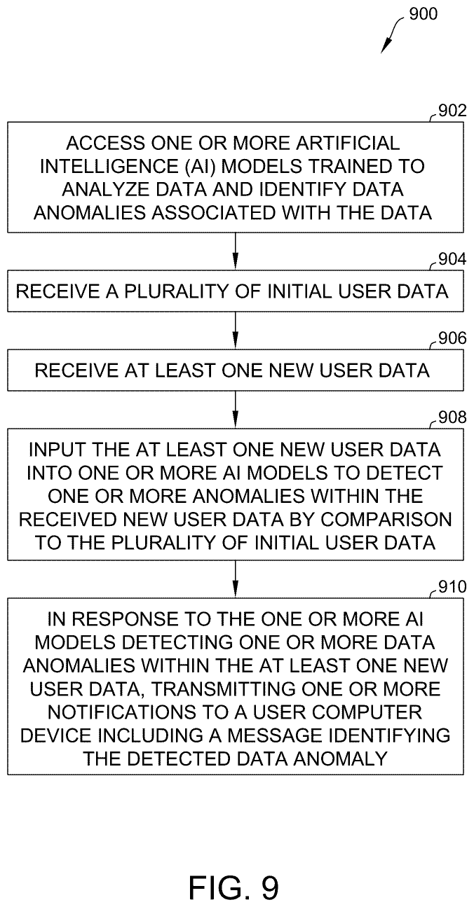

FIG. 9 illustrates a flow chart of an exemplary computer-implemented process 900 for identifying data anomalies associated with images. Process 900 may be implemented, at least in part, by a computing device/server, for example, user computing device 502 (shown in FIG. 5), server computer device 601 (shown in FIG. 6) and/or AIA computer device 102 (shown in FIG. 1).

Process 900 may include accessing 902 one or more AI models trained to analyze data and identify data anomalies associated with the data. AI models may be trained based upon prior submitted data stored in a database, and/or may be retrained based upon newly received data.

Process 900 may include receiving 904 a plurality of initial user data. Initial user data may include at least one of images, text, SOAP notes, and/or other data associated with an insurance event.

Process 900 may include receiving 906 at least one new user data. New user data may be in a format similar to initial user data, and may include at least one of images, text, SOAP notes, and/or other data associated with an insurance event.

Process 900 may include inputting 908 the at least one new user data into one or more AI models to detect one or more anomalies within the received initial user data by comparison to the plurality of initial user data. Detecting one or more anomalies may include at least one of detecting duplicate data such as notes, text, or images, comparing one or more features of the new user data to existing user data to detect duplicate data, detecting similarities between new user data and initial user data, and/or comparing a reliability score of a user associated with the new user data to a threshold score.

Process 900 may include, in response to the one or more AI models detecting one or more data anomalies within the at least one new user data, transmitting 910 one or more notifications to a user computing device including a message identifying the detected data anomaly. Transmission of one or more notifications may include removing duplicated data from the new user data or a copy of the new user data, implement one or more security measures, deploying one or more additional anomaly detection processes, flagging the data as anomalous, and/or declining a claim associated with the data based upon the detection of the anomaly.

### Exemplary Computer-Implemented Method for Detecting Appraisal Anomalies

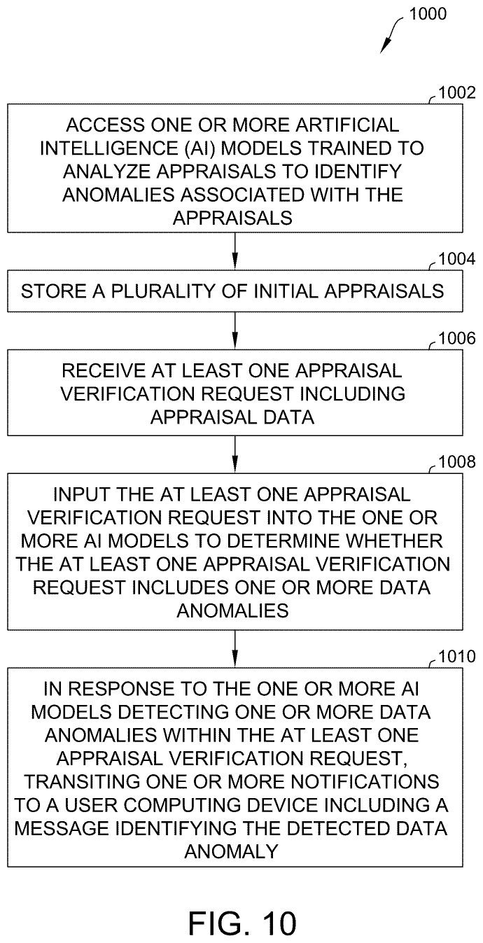

FIG. 10 illustrates a flow chart of an exemplary computer-implemented process 1000 for identifying data anomalies associated with images. Process 1000 may be implemented, at least in part, by a computing device/server, for example, user computing device 502 (shown in FIG. 5), server computer device 601 (shown in FIG. 6) and/or AIA computer device 102 (shown in FIG. 1).

Process 1000 may include accessing 1002 one or more AI models trained to analyze data and identify data anomalies associated with the data. AI models may be trained based upon prior submitted data stored in a database, and/or may be retrained based upon newly received data.

Process 1000 may include storing 1004 a plurality of initial appraisals. Appraisals may be associated with and include data related to a user, one or more items, a valuation, and/or an event.

Process 1000 may include receiving 1006 at least one appraisal verification request including appraisal data. Appraisal data may be associated with and include data related to a user, one or more items, a valuation, and/or an event.

Process 1000 may include inputting 1008 the at least one appraisal verification request into the one or more AI models to determine whether the at least one appraisal verification request includes one or more data anomalies. Determination of one or more data anomalies may include validating a valuation of an item associated with the appraisal verification request, verifying data such as images and text associated with the appraisal verification request, and/or verifying the existence or history of an appraisal vendor associated with the appraisal verification request,

Process 1000 may include, in response to the one or more AI models detecting one or more data anomalies within the at least one appraisal verification request, transmitting 1010 one or more notifications to a user computing device including a message identifying the detected data anomaly.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, OAR computer system 610 is configured to implement machine learning, such that OAR computer system 610 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images, text data, and/or other types of data. ML outputs may include, but are not limited to identified objects, items classifications, textual product, and/or other data extracted from the images or textual data. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of text with known characteristics or features. Such information may include, for example, information associated with a plurality of text of a plurality of different questions, responses, objections, items, and/or information.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may utilize voice bots or chatbots configured to utilize artificial intelligence and/or machine learning techniques as described herein. For instance, the voice or chatbot may be a ChatGPT chatbot, and may be configured to help generate a response document as described herein. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

The AI models described herein may be trained and/or retrained based upon portions of the training data. For example, AI models may be trained based upon a training data set. The training data set may be altered, transformed, have data added and/or removed, and/or otherwise changed to produce a retraining data set. Data alterations and transformations may include, for example, filtering data, masking data, transforming data, performing image and/or pixel modifications to data, and/or making any other change to data. The AI models may be retrained based upon the retraining data set, correcting deficiencies in the model and improving model capabilities and accuracy.

The AI models described herein delineate steps through which a machine learning model achieves an improvement, including at least: (i) identifying watermarks in computer-generated images, (ii) identifying similarity scores between one or more images, (iii) detecting the presence of an image modification based upon a comparison between an image and a non-AI generated image, (iv) determining the presence of an image modification based upon image attributes and/or properties, (v) generating a confidence value to determine if an image is modified, and (vi) rectifying image modifications. The AI models are improved through a delineated training and/or retraining process based upon specific datasets for improved performance in the particular field of detecting and rectifying image anomalies, including image modifications and generative AI images.

The AI models described herein further delineate steps through which a machine learning model achieves an improvement, including at least: (i) detecting anomalies between new user data and initial user data, (ii) calculating a similarity score between new user data and initial user data, (iii) determining the similarity score based on a feature comparison, (iv) determining a reliability score of an entity based upon new user data and a user history, and (v) removing and/or rectifying duplicate or similar data. The AI models are improved through training and/or retraining process based upon specific datasets for improved performance in the particular field of detecting data anomalies, including detection and remediation of reused data.

The AI models described herein further delineate steps through which a machine learning model achieves an improvement, including at least: (i) detecting data anomalies associated with appraisals, (ii) validating the existence of an appraiser, (iii) calculating an expected item value, and (iv) performing a remedial action upon detecting a data anomaly. The AI models are improved through training and/or retraining process based upon specific datasets for improved performance in the particular field of detecting data anomalies, including detection and rectification of appraisal anomalies.

### EXEMPLARY EMBODIMENTS

In one aspect, a computer system configured to detect anomalies in images may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one processor in communication with at least one memory device. The at least one processor may be configured to: access one or more artificial intelligence (AI) models trained to analyze an image and identify data anomalies associated with the image, receive at least one image for analysis, and/or input the at least one received image into the one or more AI models to determine whether the at least one received image includes one or more data anomalies. In response to the one or more AI models detecting one or more data anomalies within the at least one received image, the at least one processor may be programmed to transmit one or more notifications to a user computing device including a message identifying the detected data anomaly. The system may include additional, less, or alternate functionality, including that discussed elsewhere herein.

A further enhancement of the system may include the at least one processor further programmed to receive training images including a plurality of historical images that are predetermined as being authentic images, and/or train the one or more models using training images.

A further enhancement of the system may include the at least one processor further programmed to determine whether the at least one received image includes one or more data anomalies by determining the presence of an AI-generated watermark in the at least one image.

A further enhancement of the system may include the at least one processor further programmed to determine whether the at least one received image includes one or more data anomalies by determining the presence of an image modification in the at least one image.

A further enhancement of the system may include the at least one processor further programmed to determine the presence of an image modification in the at least one image based upon a comparison with at least one non-AI generated image.

A further enhancement of the system may include the at least one processor further programmed to determine the presence of an image modification in the at least one image based upon at least one of: a saturation value, a color value, a brightness value, a texture, a context score, or a color distribution.

A further enhancement of the system may include the at least one processor further programmed to: determine whether the at least one received image includes one or more data anomalies by determining a realism score for the at least one image and/or detecting one or more anomalies associated with the at least one image based comparing the realism score to a threshold score.

A further enhancement of the system may include the at least one processor further programmed to determine the realism score by identifying at least one feature of the at least one image, extracting the at least one feature, analyzing the at least one feature by comparing the at least one feature to at least one similar feature stored in a database, and/or determining a realism score based upon the analyzing.

A further enhancement of the system may include the at least one processor further programmed to determine the realism score by comparing at least one of a saturation value, a color value, a brightness value, a texture, a context score, or a color distribution of the at least one feature to the at least one similar feature.

A further enhancement of the system may include the at least one processor further programmed to determine whether the at least one received image includes one or more data anomalies by generating a confidence value associated with the at least one image. The confidence value may be based upon at least one of: determining the presence of an AI generated watermark in the at least one image, determining a realism score for the at least one image, and/or determining the presence of an image modification in the at least one image; and comparing the confidence value to a threshold value.

A further enhancement of the system may include the at least one processor further programmed to, upon detection of an anomaly, perform at least one of: rectifying a detected image modification, implementing one or more security measures, deploying one or more additional anomaly detection processes, flagging the at least one image as anomalous, and/or declining a claim associated with the at least one image.

In another aspect, a computer-implemented method for identifying anomalous data is provided, the computer-implemented method performed by a computing device including at least one processor and at least one memory device, is provided. The computer-implemented method includes accessing one or more artificial intelligence (AI) models trained to analyze an image and identify data anomalies associated with the image, receiving at least one image for analysis, inputting the at least one received image into the one or more AI models to determine whether the at least one received image includes one or more data anomalies, and in response to the one or more AI models detecting one or more data anomalies within the at least one received image, transmitting one or more notifications to a user computing device including a message identifying the detected data anomaly.

A further enhancement of the method may include receiving training images including a plurality of historical images that are predetermined as being authentic images, and/or training the one or more models using training images.

A further enhancement of the method may include determining whether the at least one received image includes one or more data anomalies by determining the presence of an AI-generated watermark in the at least one image.

A further enhancement of the method may include determining whether the at least one received image includes one or more data anomalies by determining the presence of an image modification in the at least one image.

A further enhancement of the method may include determining the presence of an image modification in the at least one image based upon a comparison with at least one non-AI generated image.

A further enhancement of the method may include determining the presence of an image modification in the at least one image based upon at least one of: a saturation value, a color value, a brightness value, a texture, a context score, or a color distribution.

A further enhancement of the method may include determining whether the at least one received image includes one or more data anomalies by determining a realism score for the at least one image and/or detecting one or more anomalies associated with the at least one image based comparing the realism score to a threshold score.

A further enhancement of the method may include determining the realism score by identifying at least one feature of the at least one image, extracting the at least one feature, analyzing the at least one feature by comparing the at least one feature to at least one similar feature stored in a database, and/or determining a realism score based upon the analyzing.

A further enhancement of the method may include determining the realism score by comparing at least one of a saturation value, a color value, a brightness value, a texture, a context score, or a color distribution of the at least one feature to the at least one similar feature.

A further enhancement of the method may include determining whether the at least one received image includes one or more data anomalies by generating a confidence value associated with the at least one image. The confidence value may be based upon at least one of: determining the presence of an AI generated watermark in the at least one image, determining a realism score for the at least one image, and/or determining the presence of an image modification in the at least one image; and comparing the confidence value to a threshold value.

A further enhancement of the method may include, upon detection of an anomaly, performing at least one of: rectifying a detected image modification, implementing one or more security measures, deploying one or more additional anomaly detection processes, flagging the at least one image as anomalous, and/or declining a claim associated with the at least one image.

In one exemplary embodiment, at least one non-transitory computer-readable media having computer-executable instructions embodied thereon is provided. The instructions, when executed by computing device including at least one processor and at least one memory device, the computer-executable instructions cause the at least one processor to: access one or more artificial intelligence (AI) models trained to analyze an image and identify data anomalies associated with the image, receive at least one image for analysis, input the at least one received image into the one or more AI models to determine whether the at least one received image includes one or more data anomalies, and in response to the one or more AI models detecting one or more data anomalies within the at least one received image, transmit one or more notifications to a user computing device including a message identifying the detected data anomaly.

In another aspect, a computer system for identifying anomalous data may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one processor in communication with at least one memory device. The at least one processor may be configured to access one or more artificial intelligence (AI) models trained to analyze data and identify data anomalies associated with the data and receive a plurality of initial user data. The at least one processor may be further configured to receive at least one new user data and input the at least one new user data into one or more AI models to detect one or more anomalies within the received new user data by comparison to the plurality of initial user data. The at least one processor may be further configured to, in response to the one or more AI models detecting one or more data anomalies within the at least one new user data, transmit one or more notifications to a user computing device including a message identifying the detected data anomaly. The system may include additional, less, or alternate functionality, including that discussed elsewhere herein.

A further enhancement of the system may include the at least one new user data including at least one image or at least one text entry, and the at least one new user data being associated with a user and an event.

A further enhancement of the system may include the at least one processor further programmed to train the one or more models based upon the plurality of initial user data.

A further enhancement of the system may include the one or more models including a generative AI model.

A further enhancement of the system may include the at least one processor further programmed to calculate a similarity score between the at least one new user data and the plurality of initial user data based upon the output of the execution of the one or more models.

A further enhancement of the system may include the at least one processor further programmed to calculate the similarity score based upon a comparison between a new image of the at least one new user data and an existing image of the plurality of initial user data.

A further enhancement of the system may include the at least one processor further programmed to extract at least one feature from the new image of the at least one new user data and calculate the similarity score based upon a comparison between the at least one feature of the at least one new user data and a similar feature of the existing image of the plurality of initial user data.

A further enhancement of the system may include the plurality of initial user data being associated with the user.

A further enhancement of the system may include the at least one processor further programmed to detecting the one or more anomalies is based upon comparing the similarity score to a threshold score.

A further enhancement of the system may include the at least one processor further programmed to train the one or more models based upon the plurality of initial user data.

A further enhancement of the system may include the one or more models including a generative AI model.

A further enhancement of the system may include the at least one processor further programmed to calculate a reliability score of the at least one new user data based upon a user history.

A further enhancement of the system may include the at least one processor is further programmed to, upon detection of an anomaly, perform at least one of: removing one or more duplicate or similar data, implementing one or more security measures, deploying one or more additional anomaly detection processes, flagging the data as anomalous, and/or declining a claim associated with the data.

In another aspect, a computer-implemented method for identifying anomalous data is provided, the computer-implemented method performed by a computing device including at least one processor and at least one memory device, is provided. The computer-implemented method includes accessing one or more artificial intelligence (AI) models trained to analyze data and identify data anomalies associated with the data, receiving a plurality of initial user data, receiving at least one new user data, inputting the at least one new user data into one or more AI models to detect one or more anomalies within the received new user data by comparison to the plurality of initial user data, and in response to the one or more AI models detecting one or more data anomalies within the at least one new user data, transmitting one or more notifications to a user computing device including a message identifying the detected data anomaly.

A further enhancement of the method may include the at least one new user data including at least one image or at least one text entry, and the at least one new user data being associated with a user and an event.

A further enhancement of the method may include training the one or more models based upon the plurality of initial user data.

A further enhancement of the method may include the one or more models include a generative AI model.

A further enhancement of the method may include calculating a similarity score between the at least one new user data and the plurality of initial user data based upon the output of the execution of the one or more models.

A further enhancement of the method may include calculating the similarity score based upon a comparison between a new image of the at least one new user data and an existing image of the plurality of initial user data.

A further enhancement of the method may include the plurality of initial user data is associated with the user.

A further enhancement of the method may include extracting at least one feature from the new image of the at least one new user data and calculating the similarity score based upon a comparison between the at least one feature of the at least one new user data and a similar feature of the existing image of the plurality of initial user data.

In another aspect, at least one non-transitory computer-readable media having computer-executable instructions embodied thereon is provided. The instructions, when executed by computing device including at least one processor and at least one memory device, the computer-executable instructions cause the at least one processor to: access one or more artificial intelligence (AI) models trained to analyze data and identify data anomalies associated with the data, receive a plurality of initial user data, receive at least one new user data, input the at least one new user data into one or more AI models to detect one or more anomalies within the received new user data by comparison to the plurality of initial user data, in response to the one or more AI models detecting one or more data anomalies within the at least one new user data, transmit one or more notifications to a user computing device including a message identifying the detected data anomaly.

In another aspect, a computer system configured to detect data anomalies may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one processor in communication with at least one memory device. The at least one processor may be programmed to access one or more artificial intelligence (AI) models trained to analyze appraisals to identify anomalies associated with the appraisals, store a plurality of initial appraisals, receive at least one appraisal verification request including appraisal data, and input the at least one appraisal verification request into the one or more AI models to determine whether the at least one appraisal verification request includes one or more data anomalies. The at least one processor may be further programmed to, in response to the one or more AI models detecting one or more data anomalies within the at least one appraisal verification request, transmit one or more notifications to a user computing device including a message identifying the detected data anomaly. The system may include additional, less, or alternate functionality, including that discussed elsewhere herein.

A further enhancement of the system may include the at least one processor further programmed to identify at least one of an item or an appraiser associated with the appraisal data.

A further enhancement of the system may include the at least one processor further programmed to validate the existence of the appraiser associated with the appraisal data.

A further enhancement of the system may include the at least one processor further programmed to validate the appraiser associated with the appraisal data by comparing the appraisal data to information obtained from a plurality of known anomalous claims of the plurality of initial appraisals.

A further enhancement of the system may include the at least one processor further programmed to calculate an expected value for the item based upon the plurality of initial appraisals.

A further enhancement of the system may include the appraisal data including an item valuation, and the at least one processor is further programmed to detect the one or more anomalies based upon comparing the expected value to the item valuation.

A further enhancement of the system may include the at least one processor further programmed to detect the one or more anomalies based upon comparing a feature associated with the appraisal data and a feature associated with at least one similar appraisal from the plurality of initial appraisals.

A further enhancement of the system may include the at least one processor further programmed to, upon detection of an anomaly, perform at least one of: generating a remediated valuation associated with the appraisal data, generating an insurance policy associated with the appraisal data, implementing one or more security measures, deploying one or more additional anomaly detection processes, flagging the data as anomalous, and/or declining a claim associated with the data.

In another aspect, a computer-implemented method for identifying anomalous data is provided, the computer-implemented method performed by a computing device including at least one processor and at least one memory device, is provided. The computer-implemented method includes accessing one or more artificial intelligence (AI) models trained to analyze appraisals to identify anomalies associated with the appraisals, storing a plurality of initial appraisals, receiving at least one appraisal verification request including appraisal data, inputting the at least one appraisal verification request into the one or more AI models to determine whether the at least one appraisal verification request includes one or more data anomalies, and in response to the one or more AI models detecting one or more data anomalies within the at least one appraisal verification request, transmitting one or more notifications to a user computing device including a message identifying the detected data anomaly.

A further enhancement of the method may include identifying at least one of an item or an appraiser associated with the appraisal data.

A further enhancement of the method may include validating the existence of the appraiser associated with the appraisal data.

A further enhancement of the method may include the one or more models include a generative AI model.

A further enhancement of the method may include validating the appraiser associated with the appraisal data by comparing the appraisal data to information obtained from a plurality of known anomalous claims of the plurality of initial appraisals.

A further enhancement of the method may include calculating an expected value for the item based upon the plurality of initial appraisals.

A further enhancement of the method may include the appraisal data including an item valuation, the method further comprising detecting the one or more anomalies based upon comparing the expected value to the item valuation.

A further enhancement of the method may include detecting the one or more anomalies based upon comparing a feature associated with the appraisal data and a feature associated with at least one similar appraisal from the plurality of initial appraisals.

A further enhancement of the method may include upon detection of an anomaly, performing at least one of: generating a remediated valuation associated with the appraisal data, generating an insurance policy associated with the appraisal data, implementing one or more security measures, deploying one or more additional anomaly detection processes, flagging the data as anomalous, or declining a claim associated with the data.

In another aspect, at least one non-transitory computer-readable media having computer-executable instructions embodied thereon is provided. The instructions, when executed by computing device including at least one processor and at least one memory device, the computer-executable instructions cause the at least one processor to: access one or more artificial intelligence (AI) models trained to analyze appraisals to identify anomalies associated with the appraisals, store a plurality of initial appraisals, receive at least one appraisal verification request including appraisal data, input the at least one appraisal verification request into the one or more AI models to determine whether the at least one appraisal verification request includes one or more data anomalies, in response to the one or more AI models detecting one or more data anomalies within the at least one appraisal verification request, transmit one or more notifications to a user computing device including a message identifying the detected data anomaly.

A further enhancement may include the computer-executable instructions causing the at least one processor to: identify at least one of an item or an appraiser associated with the appraisal data.

A further enhancement may include the computer-executable instructions causing the at least one processor to: validate the existence of the appraiser associated with the appraisal data.

A further enhancement may include the computer-executable instructions causing the at least one processor to: validate the appraiser associated with the appraisal data by comparing the appraisal data to information obtained from a plurality of known anomalous claims of the plurality of initial appraisals.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS′ include, but are not limited to including, Oracle® Database, MySQL, IBM® DB2, Microsoft® SQL Server, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; and Microsoft is a registered trademark of Microsoft Corporation, Redmond, Washington.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or action recited in the singular and proceeded with the word “a” or “an” should be understood as not excluding plural elements or actions, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system for identifying anomalous data, the computer system comprising at least one processor in communication with at least one memory device, wherein the at least one processor is programmed to:
access one or more artificial intelligence (AI) models trained to analyze data and identify data anomalies associated with the data;
receive a plurality of initial user data;
receive at least one new user data;
input the at least one new user data into one or more AI models to detect one or more anomalies within the received new user data by comparison to the plurality of initial user data; and
in response to the one or more AI models detecting one or more data anomalies within the at least one new user data, transmit one or more notifications to a user computing device including a message identifying the detected data anomaly.

2. The computer system of claim 1, wherein the at least one new user data includes at least one image or at least one text entry, and the at least one new user data is associated with a user and an event.

3. The computer system of claim 1, wherein the at least one processor is further programmed to train the one or more models based upon the plurality of initial user data.

4. The computer system of claim 1, wherein the one or more models include a generative AI model.

5. The computer system of claim 2, wherein the at least one processor is further programmed to calculate a similarity score between the at least one new user data and the plurality of initial user data based upon an output of an execution of the one or more models.

6. The computer system of claim 5, wherein the at least one processor is further programmed to calculate the similarity score based upon a comparison between a new image of the at least one new user data and an existing image of the plurality of initial user data.

7. The computer system of claim 5, wherein the plurality of initial user data is associated with the user.

8. The computer system of claim 6, wherein the at least one processor is further programmed to extract at least one feature from the new image of the at least one new user data and calculate the similarity score based upon a comparison between the at least one feature of the at least one new user data and a similar feature of the existing image of the plurality of initial user data.

9. The computer system of claim 5, wherein the at least one processor is further programmed to detect the one or more anomalies by comparing the similarity score to a threshold score.

10. The computer system of claim 1, wherein the at least one processor is further programmed to calculate a reliability score of the at least one new user data based upon a user history.

11. The computer system of claim 1, wherein the at least one processor is further programmed to, upon detection of an anomaly, perform at least one of: (i) removing one or more duplicate or similar data, (ii) implementing one or more security measures, (iii) deploying one or more additional anomaly detection processes, (iv) flagging the data as anomalous, or (v) declining a claim associated with the data.

12. A computer-implemented method for identifying anomalous data, the computer-implemented method implemented by a computer system including at least one memory device and at least one processor in communication with the at least one memory device and one or more user computer devices, the method comprising:
accessing one or more artificial intelligence (AI) models trained to analyze data and identify data anomalies associated with the data;
receiving a plurality of initial user data;
receiving at least one new user data;
inputting the at least one new user data into one or more AI models to detect one or more anomalies within the received new user data by comparison to the plurality of initial user data; and
in response to the one or more AI models detecting one or more data anomalies within the at least one new user data, transmitting one or more notifications to a user computing device of the one or more user computing devices including a message identifying the detected data anomaly.

13. The computer-implemented method of claim 12, wherein the at least one new user data includes at least one image or at least one text entry, and the at least one new user data is associated with a user and an event.

14. The computer-implemented method of claim 13, further comprising training the one or more models based upon the plurality of initial user data.

15. The computer-implemented method of claim 13, wherein the one or more models include a generative AI model.

16. The computer-implemented method of claim 13, further comprising calculating a similarity score between the at least one new user data and the plurality of initial user data based upon an output of an execution of the one or more models.

17. The computer-implemented method of claim 16, further comprising calculating the similarity score based upon a comparison between a new image of the at least one new user data and an existing image of the plurality of initial user data.

18. The computer-implemented method of claim 16, wherein the plurality of initial user data is associated with the user.

19. The computer-implemented method of claim 17, further comprising extracting at least one feature from the new image of the at least one new user data and calculating the similarity score based upon a comparison between the at least one feature of the at least one new user data and a similar feature of the existing image of the plurality of initial user data.

20. At least one non-transitory computer-readable storage medium having computer-executable instructions embodied thereon, wherein when executed by at least one processor, the at least one processor in communication with at least one memory, the computer-executable instructions cause the at least one processor to:
access one or more artificial intelligence (AI) models trained to analyze data and identify data anomalies associated with the data;
receive a plurality of initial user data;
receive at least one new user data;
input the at least one new user data into one or more AI models to detect one or more anomalies within the received new user data by comparison to the plurality of initial user data; and
in response to the one or more AI models detecting one or more data anomalies within the at least one new user data, transmit one or more notifications to a user computing device including a message identifying the detected data anomaly.
